(19) United States
(12) Patent Application Publication
(10) Pub. No.: US 2026/0276776 A1
(43) Pub. Date: Sep. 17, 2026

(54) METHOD AND LOCATING DEVICE FOR LOCATING RADIO TAGS, AND METHOD AND ARRANGEMENT FOR CONFIGURING THE LOCATING DEVICE

(71) Applicant: Siemens Aktiengesellschaft, München (DE)

(72) Inventors: Marc Christian Weber, München (DE); Daniel Hein, München (DE); Ferdinand Strixner, München (DE); Steffen Limmer, München (DE); Markus Häuser, Dietersheim (DE)

(21) Appl. No.: 19/140,819

(22) PCT Filed: Nov. 24, 2023
(86) PCT No.: PCT/EP2023/082928

§ 371 Date: Jun. 18, 2025

(30) Foreign Application Priority Data
Dec. 21, 2022 (EP) 22215588.9

(51) Int. Cl. G01S 5/02; G06N 3/0464

(52) U.S. Cl. CPC G01S 5/0278; G01S 5/0221; G06N 3/0464; G01S 2205/02

(57) ABSTRACT

A locating device for locating radio tags is provided, one or more first radio tags are conveyed through a specified region multiple times under various conveyor conditions. In the process, the current respective position of each first radio tag is detected by a locating sensor, a radio signal of the respective first radio tag is received, and a respective signal strength curve of the received radio signal is detected. According to the invention, the detected current positions and signal strength curves are used to train a machine learning module to reproduce a corresponding current position using at least one signal strength curve. The locating device is designed to then feed signal strength curves of received radio signals from second radio tags into the trained machine learning module and ascertain the respective current position of a respective second radio tag using the resulting output signals of the machine learning module.

### CROSS-REFERENCE TO RELATED APPLICATIONS

This application is a national stage of PCT Application No. PCT/EP2023/082928, having a filing date of Nov. 24, 2023, which claims priority to EP Application No. 22215588.9, having a filing date of Dec. 21, 2022, the entire contents both of which are hereby incorporated by reference.

### FIELD OF TECHNOLOGY

The following relates to the method and locating device for locating radio tags, and method and arrangement for configuring the locating device.

### BACKGROUND

Radio tags, for example so-called RFID transponders or RFID tags (RFID: radio-frequency identification), are very often used to monitor or detect goods, commodities or other items. Such radio tags can be read by corresponding readers by high-frequency radio waves. In many cases, the radio tag is supplied with energy by radio waves generated by the reader and therefore does not require its own energy supply.

Radio tags allow accordingly tagged objects to be easily identified and allow information to be transmitted between the radio tag and the reader.

Objects which are provided with an RFID tag can be read and/or identified by a so-called RFID gate in a surrounding area of typically a few meters. A typical RFID gate may comprise, for example, four antennas which are arranged in pairs on two separate side columns. However, configurations differing from this or a greater number of antennas is/are also widespread.

Objects provided with an RFID tag can generally be detected and read by an RFID gate with a high degree of reliability if they come sufficiently close to this RFID gate. However, it is considerably more difficult to locate an RFID tag more accurately because in many cases only the received signal strengths are available as a measurement basis and often allow only a very rough estimate of a respective distance between the RFID tag and the receiving antennas. The received signal strengths are often also referred to as RSSI values (RSSI: Received Signal Strength Indicator). In addition, the captured signal strengths are in many cases exposed to severe noise and/or are greatly influenced by items or building elements in the environment of the RFID gate. Not least, the captured signal strengths also depend on an orientation of the antennas or of the RFID tags and on the respectively tagged object.

### SUMMARY

An aspect relates to a method and a locating device for locating radio tags, and a method and an arrangement for configuring the locating device, which allow radio tags to be located in a more accurate and/or more robust manner.

This aspect is achieved by methods, by an arrangement and by a locating device.

In order to configure a locating device for locating radio tags, one or more first radio tags are conveyed many times under varied conveying conditions through a predefined area. In each case, a current position of a respective first radio tag is captured by a localization sensor, a radio signal from the respective first radio tag is received, and a respective signal strength curve of the received radio signal is captured. According to embodiments of the invention, a machine learning module is trained, on the basis of the captured current positions and signal strength curves, to reproduce a corresponding current position on the basis of at least one signal strength curve. The locating device is then configured to feed signal strength curves of received radio signals from second radio tags into the trained machine learning module and to determine a respective current position of a respective second radio tag on the basis of the resulting output signals from the machine learning module.

An arrangement for configuring a locating device for locating radio tags is provided for the purpose of carrying out the above method.

A locating device for locating radio tags is configured by carrying out the above method.

In order to locate radio tags, provision is made for a locating device to be configured according to the above method and for a current position of a second radio tag to be determined by the configured locating device.

The methods according to embodiments of the invention, the arrangement according to embodiments of the invention and the locating device according to embodiments of the invention can be carried out and/or implemented, for example, by one or more processors, computers, application-specific integrated circuits (ASIC), digital signal processors (DSP) and/or so-called “Field Programmable Gate Arrays” (FPGA). In addition, the methods according to embodiments of the invention may be at least partially carried out in a cloud and/or in an edge computing environment.

An important advantage of embodiments of the invention can be seen, in particular, in the fact that radio tags can already be located more accurately on the basis of the radio signals emitted by the latter as intended. In so far as the machine learning module in many cases can learn to distinguish radio signal patterns relevant to the position of radio tags from less relevant radio signal patterns, a locating process according to embodiments of the invention often proves to be relatively robust. In addition, embodiments of the invention require only a relatively small amount of calibration effort, since calibration data need to be generated only once for training the machine learning module, and the trained machine learning module can then be installed on a multiplicity of locating devices.

According to one embodiment of the invention, a radio tag attached to an object can be moved with the object through the area. In this manner, the training can be carried out under particularly realistic conditions. In particular, possible influencing of a signal strength curve by a respectively tagged object can be taken into account during training.

Furthermore, in order to vary the conveying conditions,
a movement trajectory, a movement direction, a movement speed, a movement pattern, an orientation, a type and/or a number of the at least one first radio tag, a movement trajectory, a movement direction, a movement speed, a movement pattern, an orientation, a type and/or a number of at least one object provided with a first radio tag,
a position or orientation of an item influencing radio signals,
an orientation of an antenna of the locating device,
a transmission power, sensitivity or setting of the locating device, and/or
a hardware configuration of the locating device can be varied. The hardware configuration may concern, for example, an antenna model used, a reader model used or a cable length between an antenna and a reader. The conveying conditions can be varied such that they cover possible and/or permissible conveying scenarios or types of use as representatively or completely as possible during operation of the configured locating device.

According to one advantageous development of embodiments of the invention, when respectively conveying one or more first radio tags through the area, in each case
a movement trajectory, a movement direction, a movement speed, a movement pattern, an orientation, a type and/or a number of the at least one first radio tag or
a movement trajectory, a movement direction, a movement speed, a movement pattern, an orientation, a type and/or a number of at least one object provided with a first radio tag can be captured as the measurement result. The machine learning module can accordingly be trained to reproduce a corresponding measurement result on the basis of at least one signal strength curve. In this manner, the locating device may be configured to also determine, in addition to the current position, different movement properties or conveying conditions of second radio tags on the basis of received radio signals.

A respective radio signal can be received by a plurality of antennas. An antenna-specific signal strength curve of the received radio signal can be captured for a respective antenna and can be assigned to an antenna identifier identifying the respective antenna. A respective signal strength curve can then be supplied, together with a respectively assigned antenna identifier, to the machine learning module. Using a plurality of antennas makes it possible to generally significantly increase the locating accuracy.

Furthermore, a respective signal strength curve can be supplied, together with a respectively received radio tag identifier, to the machine learning module. In this manner, specific properties of radio tags can be taken into account during training.

According to embodiments of the invention, a reproduction error of the machine learning module, in particular an error when reproducing a current position, can be captured. Specific signal components which at least on average reduce, in particular minimize, the reproduction error when fed into the machine learning module can therefore be searched for in captured signal strength curves. Signal components found in this manner can then be deliberately extracted from captured signal strength curves and can be fed into the machine learning module as a preprocessed signal strength curve in order to train and/or use the machine learning module. This makes it possible to identify specifically relevant signal components which allow a conclusion to be drawn about a current position or movement of the radio tag as independently as possible of environmental properties, antenna characteristics or other influences not caused by the movement of a radio tag.

According to a further advantageous development of embodiments of the invention, the trained machine learning module can be retrained at a place of use of the locating device on the basis of position data captured at the place of use. Localization data from an object monitoring system of an operator or manually input localization data, confirmation data and/or correction data can be used as position data, in particular. Alternatively or additionally, a so-called auto-labeling method can also be carried out, for example via cluster analysis.

According to an embodiment of the invention, a respective signal strength curve of received radio signals can be interpolated to a predefined time frame. The respectively interpolated signal strength curve can then be fed into the machine learning module. In this manner, a set of data to be processed by the machine learning module can be adapted to an actual rate of change of the signal strengths. The time frame may typically be formed from times at an interval of a few seconds.

Furthermore, an optical sensor, a camera, a radio-wave-based sensor, a proximity sensor and/or a laser scanner can be used as the localization sensor. In particular, the localization sensor may be implemented on the basis of a lidar, radar, RTLS (Real-Time Locating System), Bluetooth, WLAN or 5G system. A plurality of such localization sensors, in particular a plurality of cameras, can be used.

The machine learning module can comprise a recurrent neural network, an LSTM network (LSTM: Long Short-Term Memory), a convolutional neural network and/or a temporal convolutional neural network. Time series data, in particular, can be processed very efficiently using such neural networks.

According to a further advantageous development of embodiments of the invention, a plurality of signal strength curves can be fed into the machine learning module and an individual prediction of a position of a second radio tag can be output in each case. The current position of the second radio tag can then be determined by a combination of the individual predictions. In this manner, a locating accuracy can generally be significantly increased. In particular, individual incorrect predictions, for example on account of a short-term signal failure or particularly strong interference, can generally be effectively compensated. Such an aggregation of individual predictions to form an overall result can also be optimized by specific training of the machine learning module or of a further machine learning module. For this purpose, a manner in which the individual predictions should be combined can be parameterized by setting parameters, wherein the setting parameters are set in such a manner that a prediction error of the relevant machine learning module is minimized. This makes it possible to implement, in particular, a hierarchical machine learning model.

### BRIEF DESCRIPTION

Some of the embodiments will be described in detail, with reference to the following figures, wherein like designations denote like members, wherein:

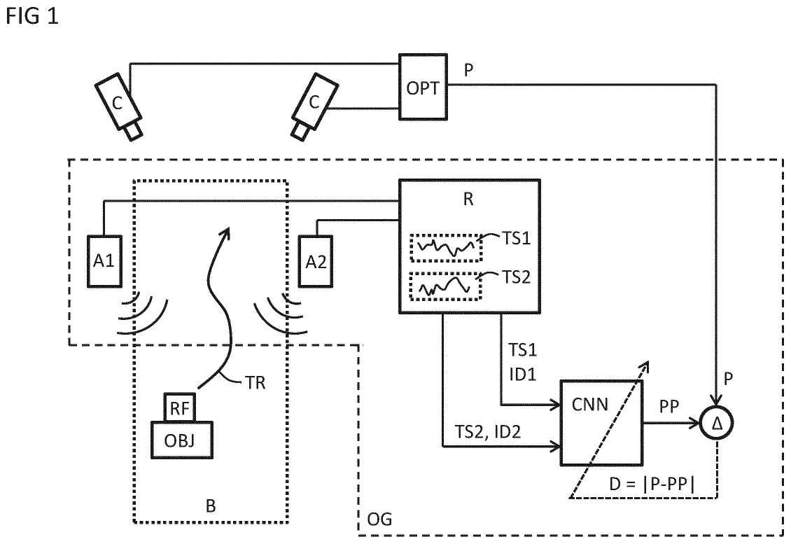

FIG. 1 shows an arrangement for configuring a locating device; and

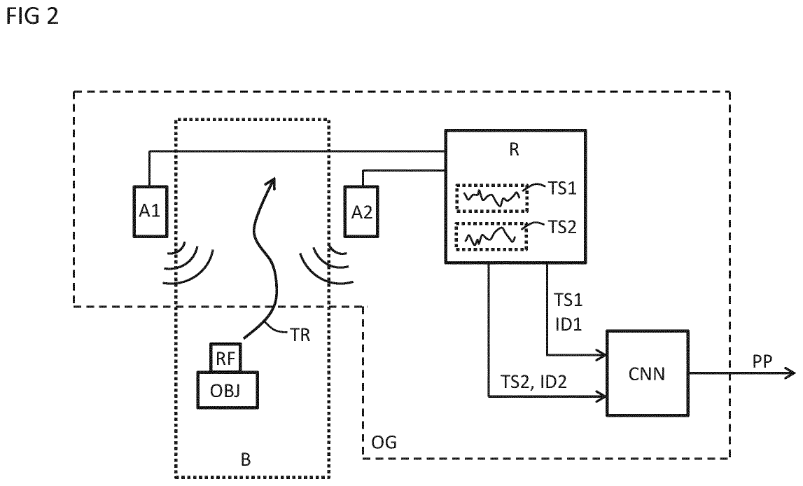

FIG. 2 shows intended operation of the configured locating device.

Insofar as identical or corresponding reference signs are used in the figures, these reference signs denote identical or corresponding entities which can be implemented or configured, in particular, as described in connection with the relevant figure.

FIG. 1 illustrates a schematic representation of an arrangement for configuring a locating device OG. In this case, the locating device OG may be, in particular, an RFID gate or a part of the latter. The locating device OG is used to monitor a predefined area B, through which objects OBJ, for example parcels, packaging, products, product components, robotic vehicles etc. move. The area B may be, for example, a transport area or a conveyor belt of a depot, a logistics center, a warehouse or a production plant. In order to identify and/or locate the objects OBJ, they are each provided with a radio tag RF, for example an RFID tag.

According to embodiments of the invention, the locating device OG is intended to be configured in such a manner that it can locate radio tags RF moved through the area B as accurately and/or robustly as possible on the basis of the radio signals received from the radio tags.

For this purpose, the locating device OG has a reader R for radio tags, a plurality of antennas A1 and A2 coupled to the reader R and a machine learning module CNN. In the present exemplary embodiment, the machine learning module CNN comprises a convolutional neural network, in particular a temporal convolutional neural network. Alternatively or additionally, the machine learning module CNN may comprise a recurrent neural network, an LSTM network or another neural network. The machine learning module CNN is intended to be trained to predict current positions of radio tags RF.

Training should generally be understood as meaning optimization of a mapping of input signals of a machine learning module, here CNN, to its output signals. This mapping is optimized according to one or more predefined criteria during a training phase. A prediction error can be used, in particular in the case of prediction models, as a criterion. The training makes it possible to set or optimize, for example, networking structures of neurons of a neural network and/or weights of connections between the neurons in such a manner that the predefined criteria are satisfied as well as possible. The training can therefore be interpreted as an optimization problem. For such optimization problems in the field of machine learning, a multiplicity of efficient optimization methods are available, in particular gradient-based optimization methods, gradient-free optimization methods, backpropagation methods, particle swarm optimizations, genetic optimization methods and/or population-based optimization methods.

In particular, artificial neural networks, recurrent neural networks, convolutional neural networks, LSTM networks, deep learning architectures, support vector machines, Bayesian neural networks, autoencoders, Gaussian processes, data-driven regression models, K-nearest neighbor classifiers, physical models or decision trees can therefore be trained.

In the present exemplary embodiment, in order to train the machine learning module CNN, objects OBJ provided with first radio tags RF are moved many times under varied conveying conditions, in particular on different movement trajectories TR, through the area B. Here and below, radio tags used for training are referred to as first radio tags, whereas radio tags that need to be located during intended operation are referred to as second radio tags. This distinction is used only to distinguish the training phase from an application phase and does not imply, in particular, any structural differences between first and second radio tags. In fact, (first) radio tags which are identical or similar to the (second) radio tags to be located during intended operation are used for training. Accordingly, first and second radio tags are indicated with the same reference signs in the figures.

The conveying conditions are varied during the training phase in such a manner that they cover as completely and/or representatively as possible the conveying scenarios, types of use or influencing factors which are possible and/or permissible during intended operation of the configured locating device OG. In particular, the movement trajectories TR are varied over the entire area B and/or with respect to a movement direction, a movement speed or a movement pattern. Furthermore, an orientation, a type and/or a number of the objects OBJ moved through the area B can be varied. In addition, a position or orientation of an item influencing radio signals in the area B or in its environment, an orientation of the antennas A1, A2 and/or a transmission power, sensitivity, setting or hardware configuration of the locating device OG can be varied.

In order to locate the objects OBJ and therefore the first radio tags RF, a plurality of cameras C are directed at the area B and continuously record images of the area B from different directions, for example in plan view and profile view. The cameras C are coupled to an optical evaluation device OPT, to which the recorded images are continuously transmitted.

The optical evaluation device OPT is used to continuously detect and locate the objects OBJ. As an alternative or in addition to the cameras C, other localization sensors may be provided for the purpose of locating the objects OBJ, for example radio-wave-based sensors, proximity sensors or laser scanners.

In the present exemplary embodiment, a respective current position P of a respective object OBJ and therefore of a respective radio tag RF is continuously determined over the course of time by the optical evaluation device OPT on the basis of the transmitted images. A position vector, a movement vector and/or an indication of the zone of the area B in which a respective object OBJ is currently located can be determined, in particular, as the current position P. For the last-mentioned purpose, the area B can be divided, for example, into zones to the left and right of a central axis of an RFID gate and/or into zones inside and outside a radio range of the RFID gate.

If a discrete zone indication is determined as the current position P, the machine learning module CNN can be trained, by known relevant methods, to carry out a discrete classification. If a quasi-continuous position or movement variable is determined as the current position P, the machine learning module CNN can be trained, by likewise relevant methods, to output a quasi-continuous prediction. Training of the machine learning module CNN is explained in more detail below.

Further data relating to the movements of the objects OBJ can also be determined in a time-resolved manner as measurement results by the optical evaluation device OPT, for example a respective orientation, a respective movement direction, a respective movement speed, a respective movement pattern, a respective type and/or a number of the objects OBJ. The measurement results can then be used to train the machine learning module CNN to also reproduce the measurement results in addition to a current position.

A multiplicity of known optical pattern or object recognition methods are available for evaluating the images by way of the optical evaluation device OPT.

Furthermore, the reader R emits, via the antennas A1 and A2, radio waves into the area B, which are received by a first radio tag RF respectively located therein and temporarily supply the latter with energy. The respective first radio tag RF consequently emits, during its movement through the area B, a radio signal that is received by the antennas A1 and A2 and is forwarded to the reader R. The radio signal contains, inter alia, a radio tag identifier (not illustrated) identifying this first radio tag RF.

While the respective first radio tag RF is moved through the area B, the reader R captures a respective temporal curve TS1 of a signal strength of the radio signal received by the antenna A1 and a respective temporal curve TS2 of a signal strength of the radio signal received by the antenna A2. The antenna-specific signal strength curves TS1 and TS2 are each captured in the form of a temporal sequence, that is to say in the form of a time series of so-called RSSI values. If necessary, the signal strength curves TS1 and TS2 are each interpolated to a predefined time frame with a time interval of, for example, 1 s, 2 s, 5 s or 10 s and are processed further in the interpolated form.

In order to increase an amount of training data available for training, provision may be optionally made for the determined positions P and, in parallel therewith, the signal strength curves TS1 and TS2 to be mirrored on one or more planes of symmetry or axes of symmetry of the arrangement of the antennas, here A1 and A2. In the present exemplary embodiment, according to FIG. 1, mirroring on the plane of symmetry between the antennas A1 and A2 would correspond to mirroring of the positions P on this plane of symmetry and swapping of the signal strength curves TS1 and TS2. The mirrored training data can then be added to the measured, unmirrored positions P and signal strength curves TS1 and TS2. Such an expansion of the training data may in many cases significantly increase robustness of the predictions of the machine learning module CNN. In embodiments, pure memorization of the specific geometry of the antenna arrangement can be reduced as it were.

In order to train the machine learning module CNN, both the respective signal strength curve TS1 assigned to an antenna identifier ID1 identifying the antenna A1 and the respective signal strength curve TS2 assigned to an antenna identifier ID2 identifying the antenna A2 are fed from the reader R into the machine learning module CNN as temporally resolved input signals. In some embodiments, the respectively received radio tag identifier can also be supplied to the machine learning module CNN.

The aim of the training is for the machine learning module CNN to reproduce an actually captured current position, here P, as well as possible on the basis of antenna-specific signal strength curves that have been fed in, here TS1 and TS2. That is to say, an output signal PP from the machine learning module CNN corresponds at least on average as well as possible to the actually determined current position P.

For this purpose, a discrepancy D between the respective output signal PP and the respectively captured current position P is determined in each case. The discrepancy D in this case represents a reproduction or prediction error of the machine learning module CNN. The discrepancy D can be calculated, in particular, as a square or absolute value of a difference, in particular a vector difference, according to D=(P−PP)² or D=|P−PP|. The discrepancy D is determined individually for each of the many times first radio tags RF are conveyed through the area B.

The discrepancies D determined during the training phase are fed back to the machine learning module CNN, as indicated by a dashed arrow in FIG. 1. The machine learning module CNN is trained, on the basis of the discrepancies D that have been fed back, to at least on average minimize these discrepancies D and therefore the reproduction error. As already indicated above, a multiplicity of known optimization methods are available for minimizing the discrepancies D, for example gradient descent methods, particle swarm optimizations or genetic optimization methods. In this manner, the machine learning module CNN is trained, by a supervised learning method, to predict a current position of a respective object OBJ and therefore of the respective radio tag RF in a relatively accurate manner on the basis of antenna-specific signal strength curves that have been fed in.

In some embodiments, in order to improve prediction quality, specific signal components which at least on average reduce the reproduction error D when fed into the machine learning module CNN can be deliberately searched for in the respectively captured signal strength curves. Signal components found in this manner can then be extracted from the captured signal strength curves and used as input signals to train the machine learning module CNN. Alternatively or additionally, it is possible to search for signal components which have a negative influence on the reproduction error D. Such signal components can then be removed from the relevant signal strength curves before they are used to train the machine learning module CNN.

FIG. 2 illustrates a schematic representation of intended operation of the locating device OG which was configured by the above-described training of the machine learning module CNN. In addition to the locating device OG used for training, the trained machine learning module CNN can also be used by other identical or similar locating devices, as described below.

During intended operation, the configured locating device OG is intended to locate objects OBJ, which are moved through the area B and are each provided with a second radio tag RF, on the basis of received radio signals.

For this purpose, the reader R emits radio waves into the area B via the antennas A1 and A2, which radio waves are received by a second radio tag RF respectively located in the area B and attached to an object OBJ and temporarily supply the second radio tag with energy. The respective second radio tag RF consequently emits a radio signal during its movement through the area B, which radio signal is received by the antennas A1 and A2 and is forwarded to the reader R. As described above, the reader R captures a respective antenna-specific signal strength curve TS1 or TS2 of the radio signal and feeds it, together with the associated antenna identifier ID1 or ID2, into the trained machine learning module CNN as an input signal. If necessary, the signal strength curves may be interpolated to a predefined time frame beforehand. In addition-as indicated above-signal components with a positive influence on prediction quality can be fed into the trained machine learning module CNN. In a complementary manner, signal components with a negative influence on the prediction quality can be removed from the relevant signal strength curves before they are fed in.

The trained machine learning module CNN then predicts a current position PP of the respectively tagged object OBJ or radio tag RF and possibly further data relating to the movement of the object OBJ on the basis of the antenna-specific signal strength curves TS1 and TS2 that have been fed in. The predicted current position PP and possibly the further movement data are finally output as intended by the configured locating device OG.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for configuring a locating device for locating radio tags, the method comprising:
a) conveying one or more first radio tags many times under varied conveying conditions through a predefined area, wherein in each case
a current position of a respective first radio tag is captured by a localization sensor, and
a radio signal from the respective first radio tag is received and a respective signal strength curve of the received radio signal is captured;
b) training a machine learning module on a basis of the captured current positions and signal strength curves, to reproduce a corresponding current position on a basis of at least one signal strength curve; and
c) configuring the locating device to feed signal strength curves of received radio signals from second radio tags into the trained machine learning module and to determine a respective current position of a respective second radio tag on a basis of the resulting output signals from the machine learning module, wherein a reproduction error of the machine learning module is captured,
wherein specific signal components which at least on average reduce the reproduction error when fed into the machine learning module are searched for in captured signal strength curves, and
wherein signal components found in this manner are deliberately extracted from captured signal strength curves and are fed into the machine learning module in order to train and/or use the machine learning module.

2. The method as claimed in claim 1, wherein a radio tag attached to an object is moved with the object through the area.

3. The method as claimed in claim 1, wherein
in order to vary the conveying conditions,
a movement trajectory, a movement direction, a movement speed, a movement pattern, an orientation, a type and/or a number of the at least one first radio tag,
a movement trajectory, a movement direction, a movement speed, a movement pattern, an orientation, a type and/or a number of at least one object provided with a first radio tag,
a position or orientation of an item influencing radio signals,
an orientation of an antenna of the locating device,
a transmission power, sensitivity or setting of the locating device, and/or
a hardware configuration of the locating device is/are varied.

4. The method as claimed in claim 1, wherein
when respectively conveying one or more first radio tags through the area, in each case
a movement trajectory, a movement direction, a movement speed, a movement pattern, an orientation, a type and/or a number of the at least one first radio tag or
a movement trajectory, a movement direction, a movement speed, a movement pattern, an orientation, a type and/or a number of at least one object provided with a first radio tag
is/are captured as the measurement results; and
in that the machine learning module is trained to reproduce a corresponding measurement result on the basis of at least one signal strength curve.

5. The method as claimed in claim 1, wherein
a respective radio signal is received by a plurality of antennas,
in that an antenna-specific signal strength curve of the received radio signal is captured for a respective antenna and is assigned to an antenna identifier identifying the respective antenna, and
in that a respective signal strength curve is supplied, together with a respectively assigned antenna identifier, to the machine learning module.

6. The method as claimed in claim 1, wherein
a respective signal strength curve is supplied, together with a respectively received radio tag identifier, to the machine learning module.

7. The method as claimed in claim 1, wherein
the trained machine learning module is retrained at a place of use of the locating device on the basis of position data captured at the place of use.

8. The method as claimed in claim 1,
wherein a respective signal strength curve of received radio signals is interpolated to a predefined time frame, and
in that the respectively interpolated signal strength curve is fed into the machine learning module.

9. The method as claimed in claim 1,
wherein an optical sensor, a camera, a radio-wave-based sensor, a proximity sensor and/or a laser scanner is/are used as the localization sensor.

10. The method as claimed in claim 1,
wherein the machine learning module comprises a recurrent neural network, an LSTM network, a convolutional neural network and/or a temporal convolutional neural network.

11. A method for locating radio tags, wherein
a locating device is configured as claimed in claim 1, and
a current position of a second radio tag is determined by the configured locating device.

12. The method as claimed in claim 11,
wherein a plurality of signal strength curves are fed into the machine learning module and an individual prediction of a position of the second radio tag is output in each case, and
in that the current position is determined by a combination of the individual predictions.

13. An arrangement for configuring a locating device for locating radio tags, configured to carry out the method as claimed in claim 1.

14. A locating device for locating radio tags, configured by carrying out a method as claimed in claim 1.
